(19) United States
(12) Patent Application Publication
(10) Pub. No.: US 2016/0011653 A1
(43) Pub. Date: Jan. 14, 2016

(54) Method for controlling energy consumption in a wrist wearable device, and a device using same

(71) Applicant: Elektrobit Wireless Communications Oy, Oulu (FI)

(72) Inventors: Sami KOTKAJUURI, Kangasala (FI); Klaus MÄNTYSAARI, Oulu (FI)

(21) Appl. No.: 14/326,595

(22) Filed: Jul. 9, 2014

(51) Int. Cl. G06F 1/32; G06F 3/01

(52) U.S. Cl. CPC G06F 1/3296; G06F 3/014

(57) ABSTRACT

The present invention comprises a method and an apparatus for controlling power supply to reduce power consumption in a display of a wrist wearable device. One challenge is to avoid turning the display unnecessarily on. For example, when a user is running, the user's wrist swings during the running so that the display is occasionally in a predetermined orientation. The invention enables activation of the display only if the display stays in this orientation longer than a predetermined check period. If the user, however, wants to watch the display while running, the display is turned on when the user holds his/her arm in such position that the predetermined orientation of the display is detected twice and the later orientation detection is based on measurements which are made after the predetermined check period.

### TECHNICAL FIELD

The present invention relates generally to power consumption of a wearable device comprising a display, such as a smart-watch and the like.

### BACKGROUND OF THE INVENTION

Smart-watches, mobile phones, and tablet PCs are some examples of hand-held devices using a battery or an accumulator as a power source. Consumers prefer to use hand-held devices whose power lasts long and thus it is desirable to save power as long as the power saving does not deteriorate the user-experience. A wrist wearable device usually, but not necessarily, includes a watch. Some smart-watches measure physiological features of a human body, such as heart beats, for health purposes. Those devices may include a communication unit for alarming a health care staff, for example, when a user's heart functions abnormally. Some wrist-wearable devices are intended for training or monitoring a sport related activity or exercise.

A wrist wearable device is a relatively small device and therefore its power source is also relatively small. Therefore, unnecessary power consumption should be avoided. A battery lifetime can be lengthened by putting the device or some of its components to “sleep mode” when the device is not in use. The device or its component is awakened only when needed. Typically, a display is a major energy consumer. There are various types of displays, and touch detection capable display (colloquially ‘touch display’) are often used. Most displays can be in on or off state. Optionally, the display has a backlight which may be dimmed to one or more intermediate intensity levels. Different aspects of the display effect the power consumption. The backlight, touch sensitive portion, and the like, may each be considered a portion of the display, and are oftentimes controllable separately, to control; the power consumption of the display as a whole. Thus for example the display consumes more energy when the backlight is on than when it is off, higher intensity level cause higher power consumption, and touch capability normally consumes additional energy. Energy consumers such as a display and/or its backlight, and touch sensitivity can be managed by a timer which turns the one or more consumers off when the timer expires. Thereafter some user action is needed to turn the display and/or the backlight on. The user action may be, by way of example, pressing a button.

U.S. Pat. No. 8,702,430 discloses an electronic sport training system that comprises at least one monitor and a portable electronic processing device for receiving monitor data and providing feedback to an individual. The monitor can be a motion monitor measuring the individual's performance, such as speed, pace, and distance. For example, runners benefit from such feedback. Some monitors may monitor a heart rate, a body temperature, an altitude, and the like. The monitoring may also comprise monitoring movements of a user's wrists. The feedback provided to the user may include information whether the user has reached a certain workout or training criteria.

U.S. Pat. No. 8,379,488 describes a smart-watch comprising a top-display, an inside display, and a hinge coupling a base part of the smart-watch to a flip-up portion and information is displayed on the inside display only when the flip-up portion is in an open position. The inside display is turned off when the flip up portion is in a closed position. In one embodiment the hinge includes a position sensor which detects a displacement of the flip-up portion in relation to the base. A processor communicates with the position sensor and controls activation of the inside display.

A drawback of the above-mentioned flip-up portion is similar to that of a regular button: the user must manually open the flip-up portion. A smart watch, and especially one that is frequently viewed, may benefit from easier control of the display.

U.S. Pat. No. 8,626,248 describes a solution based on using two sensors: a proximity sensor and an accelerometer. The display of a mobile device is managed during a voice communication session using the proximity sensor and the accelerometer. The display is turned off during a phone call, if the proximity sensor detects an object nearby the mobile device and the accelerometer determines that the mobile device is in a certain orientation, such as during a telephone call. The object located near the mobile device is assumed to be a user's head and the certain orientation is a vertical orientation. By means of the proximity sensor and the accelerometer it is possible to determine that the user holds the mobile device to his/her ear and cannot see the display. Therefore, the display is turned off to reduce power consumption.

There is therefore a heretofore unresolved need for comfortable automated apparatus and method that would automatically turn power consuming portions of a wrist wearable device on or off, to make such devices consume power only when their operation is required.

### BRIEF DESCRIPTION

It is a goal of the invention to determine when a display of a wrist wearable device should be turned on. In an aspect of the invention, If a user wants to watch the display, the user lifts his/her hand and turns the wrist so that the display is substantially in a horizontal orientation or generally facing the user such that the display is visible. In response to the display orientation, and to holding the display within that orientation for a predetermined period, a trigger activates the display.

Importantly, the wearable device may be only at one orientation at any given instant, and an orientation sensed by a sensor relates to such instantaneous orientation. However while relating to an orientation used to determine activation and/or deactivation of the display and/or portions thereof, the term orientation generally relates to at least one specific orientation, but more commonly to a range of orientations, and the term extends to a single orientation or any number of orientations within one or more ranges each defining horizontal and/or vertical orientation limits. The term orientation range may relate to one continuous range or to several discontinuous ranges. Furthermore, in certain optional embodiments the term orientation may extend to include acceleration.

Thus in an aspect of the invention, there is provided a wrist wearable device comprising at least a display, a sensor, and a processor; the processor being coupled to the sensor and to the display controller, wherein the processor is configured to obtain a first a first dataset from the sensor, the dataset corresponding to a first instantaneous orientation; after a predetermined delay, obtain a second dataset, the second data set corresponding to a second instantaneous orientation; and activate the display or a portion thereof, if the first and the second instantaneous orientations fall within a predetermined orientation range.

Optionally the first data set and the second data sets are obtained from different sensors.

Optionally the predetermined orientation range in which the display is turned activated is adjustable. By certain user action, the user can specify in which orientation or range of orientations he/she prefers to have the display or portions thereof activated and/or deactivated.

Optionally the predetermined delay between obtaining the first and second data sets is adjustable.

In certain embodiments, the wrist wearable device may be further configured to deactivate the display or portions thereof. The deactivation may be responsive to a predetermined time delay, and such deactivation may be controlled by the processor or by other circuitry. Alternatively deactivation may be responsive to obtaining a third dataset corresponding to a third instantaneous orientation and deactivating the display if the third orientation is outside of the predetermined orientation range. The third data set is obtained after a predetermined delay from activating the display. The skilled in the art will recognize that the delay preceding the obtainment of the third dataset may equivalently be considered from any event that caused the activation of the display, such as from obtaining the first or second datasets, from determining to activate the display, and the like, and that such delay should be considered equivalent to a delay measured from the time the display is activated.

An aspect of the invention comprises a method for controlling a display of a wrist wearable device. In one embodiment the method comprises the steps of obtaining a first data set from at least one sensor, the first dataset corresponding to a first orientation of the display. After a predetermined delay, obtaining a second dataset corresponding to a second orientation, and activating the display, if the first and the second orientations fall within at least one predetermined orientation range. The steps of obtaining the first and second datasets from the sensor, and of activating the display are performed by a processor. Optionally, the first dataset is obtained from a different sensor than the second dataset.

Optionally, the method further supports the step of obtaining a third data set corresponding to a third orientation, and deactivating the display if the third orientation falls outside the orientation range. The third dataset is obtained after a delay from the activation of the display. Alternatively a timer may deactivate the display.

Further optionally the method may further comprise steps for setting the orientation range or ranges, time delays, portions of the display to activate or deactivate, and the like.

### BRIEF SUMMARY OF DRAWINGS

For a more complete understanding of examples and embodiments of the present invention, reference is now made to the following descriptions taken in connection with the accompanying drawings in which:

FIG. 1A shows a wrist wearable device and its display turned off,

FIG. 1B shows the display turned on,

FIG. 2 shows coordinate axes and two display orientations,

FIG. 3A shows a user's arm in a first position,

FIG. 3B shows the user's arm in a second position,

FIG. 4 shows tilting the wrist wearable device,

FIG. 5A shows a method for controlling power supply,

FIG. 5B optional steps of the method,

FIG. 6 shows an apparatus for controlling power supply.

### DESCRIPTION

It is appreciated that the following embodiments are exemplary. Although the specification may refer to “one” or “another” embodiment, the reference is not necessarily made to the same embodiment(s), or the feature in question may apply to multiple embodiments. Single features of different embodiments may be combined to provide further embodiments.

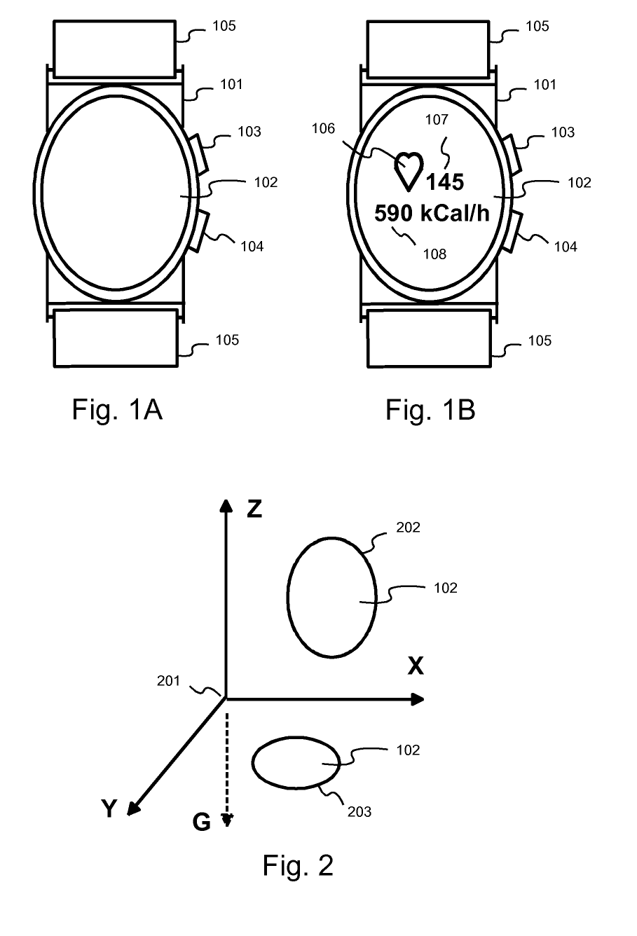

FIG. 1A shows a wrist wearable device 101 and its display 102. While the shown examples use generally elongated, elliptical shape, the device and the display may be of any desired shape. The device includes two buttons 103, 104 and a wristband 105 for securing device 101 to a user's wrist. Display 102 is shown turned off.

FIG. 1B shows the device of FIG. 1A, with the display 102 turned on. In this example it is assumed that the user of wrist wearable device 101 has run and then stopped to watch display 102. The content shown on the display includes a heart 106 symbolizing a pulse, a pulse rate indication 107, and an estimate 108 of calories burned in an hour.

The content shown on display 102 may be provided by some training application, but it will be clear to the reader that the display may be of any desired information, such as time, navigational data, other sensor related data, communication information, images, and the like. Wrist wearable device 101 can be used as a platform for various applications, such as applications providing sport, health, or any other information. That information is a part of the content shown on display 102. In addition to mechanical buttons 103, 104, the user interface of wrist wearable device 101 may comprise a touch panel, in which case buttons, icons, and/or other user interface graphics may be shown on display 102. The icons, or graphics in general, represent a part of the content shown on display 102. The display 102 may include a backlight. When the backlight is turned off, the content of display 102 is blank as in FIG. 1A. When the backlight is turned on, some application-specific content is visible on display 102. The backlight may be controlled to any number of intermediate levels, and change in such intermediate level from lower to brighter constitutes activation of the display. The touch sensitivity of display 102 may also be activated or deactivated. Wrist wearable device 101 aims to save power so that it does not display content, if a user cannot see the content, or does not need it a given time. Separating different user needs and use cases from each other is one challenge to be solved. One part of the solution is detecting the orientation of display 102 in reliable manner.

FIG. 2 shows display 102 of wrist wearable device 101, a coordinate system 201, and two different display orientations 202, 203. Coordinate system 201 is a three dimensional Cartesian coordinate system with X, Y, and Z axis, and an origin at the meeting of the three axis. Vector G is located on the Z axis and represents gravity. In the first orientation 202, which is termed “horizontal orientation”, the (outer) surface of display 102 is parallel with a plane defined by X and Y axis. In the second orientation 203, which is termed “vertical orientation”, the surface of display 102 is perpendicular to the plane defined by X and Y axis. Because wrist wearable device 101 includes an appropriate sensor, such as an accelerometer by way of example, wrist wearable device 101 can detect when the display orientation changes between horizontal orientation 202 to vertical orientation 203 or vice versa.

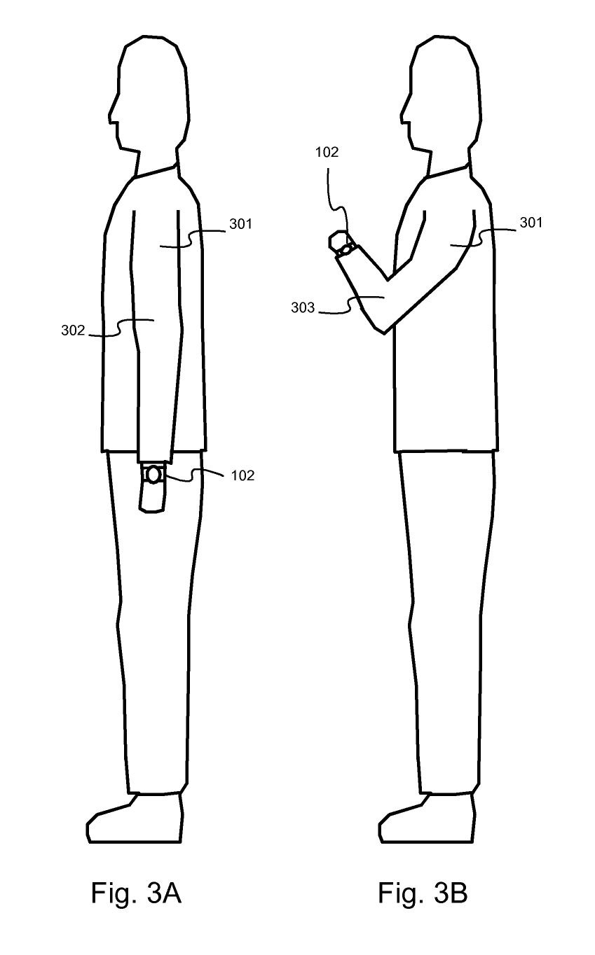

FIG. 3A shows a user holding his arm 301 in a first position 302. When his arm is in this natural position, he cannot see display 102 of wrist wearable device 101. Therefore, it is natural to select vertical orientation 203 of display 102 as the display orientation in which display 102 is turned off.

FIG. 3B shows the user holding his arm 301 in a second position 303. The user has lifted his wrist and twisted his arm so that he sees display 102 of wrist wearable device 101. When the user moves his arm to the second position 303, display 102 is moved to horizontal orientation 202, which triggers the activation of display 102. Some portion of power is supplied to display 102, for example, to turn a backlight of the display on. Optionally, the power supplied to the display or portions thereof affects the content to be shown to the user. FIG. 1B shows one example of the content.

Horizontal orientation 202 is an example of a predetermined orientation of display 102 in which the display 102 is activate to one extent or another. The predetermined position may be fixed, i.e. not user adjustable. Alternatively, a user of wrist wearable device 101 may adjust the predetermined orientation, or a range of orientations.

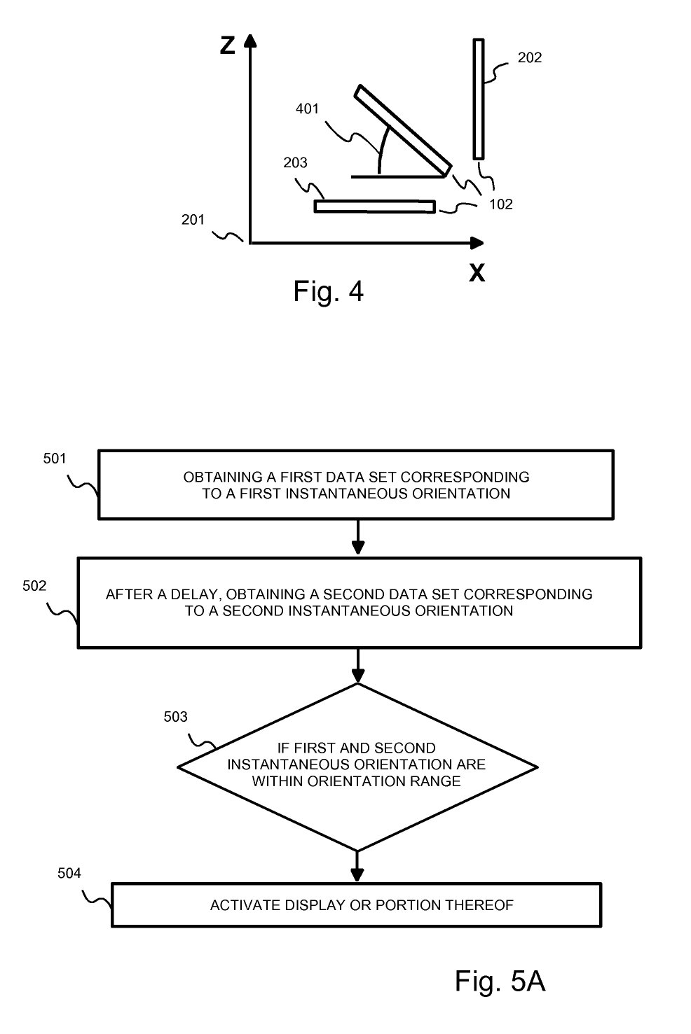

FIG. 4 shows an example of tilting of wrist wearable device 101. In one embodiment a tilting angle 401, which causes turning on display 102, is fixed. The angle, for example, 30° from horizontal orientation 202 towards the user's faces. In another embodiment a user given a possibility to choose and set tilting angle 401. Certain angle may make easier to see display 102. The predetermined orientation of display 102 may therefore be another orientation than horizontal orientation 202 or vertical orientation 203. A user, however, does not need to move the display exactly to the predetermined orientation to turn on display 102. The display orientation may differ, by a tolerance, such as 10 degrees from the predetermined orientation by way of example. Within this tolerance the display orientation will be considered to fall within the predetermined orientation. The tolerance may be fixed or user adjustable. Alternatively, the user can specify an exact range, either numerically, or by placing his arm in several limit orientations.

A user can express his/hers need to use display 102 by moving display 102 of wrist wearable device 101 to the predetermined orientation. Sometimes, however, the predetermined orientation is reached unintentionally. For example, during running the user's arm 301 may swing to position 303 shown in FIG. 3B. More than one orientation measurement is needed to determine whether the predetermined orientation is intentionally reached. Therefore, the orientation of display 102 is measured at least twice. The orientation is sensed by at least one sensor, to provide a first measurement, and after a predetermined check period, i.e. delay, the orientation of display 102 is checked again. The predetermined check period may be fixed or user adjustable. A period of one or two seconds may be selected by way of example, but shorter times are also considered. The period should be long enough to avoid unnecessary activation.

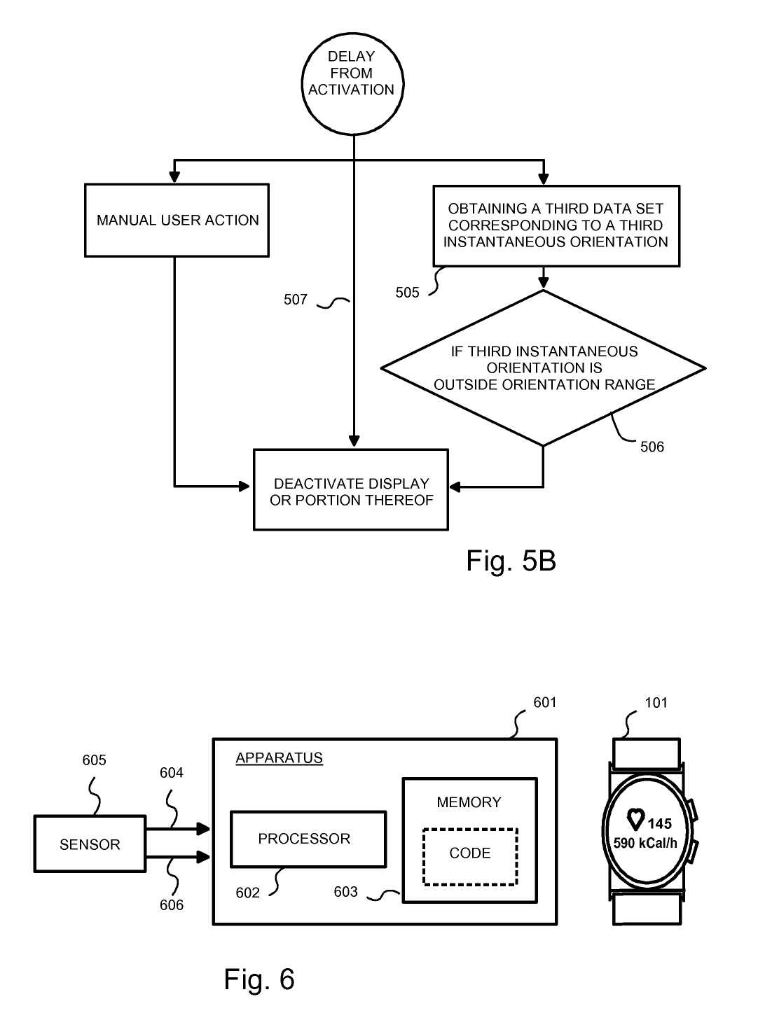

FIG. 5A shows steps of an exemplary method in accordance with certain aspects of the invention. The method controls power supply to the display, to reduce the power consumption of display 102 of wrist wearable device 101. The method comprises at least the steps of:
obtaining 501 a first data set from at least one sensor providing a first measurement, the first data set corresponding to a first orientation of the display;
obtaining 502 a second data set, providing a second measurement, the second data set corresponds to a second orientation of the display after a predetermined delay from the first measurement;
detecting 503 a user need targeted to the display when the first orientation as well as the second orientation substantially correspond to a predetermined orientation of the display; and in response to the user need
supplying 504 a portion of power to the display to present a content, or stated differently, activating the display, or any portion thereof, if the first and the second orientations fall within a predetermined orientation range.

FIG. 5B shows optional steps of the method. The power supply to display 102 can be stopped, and thus the display would be deactivated when a user probably cannot see display 102 (or does not want to watch it),In such optional embodiment the following steps are also performed:
obtaining 505 a third data set the new data set corresponding to a third orientation of the display, this step being performed after the second measurement of FIG. 5A; and
stopping 506 the supply of power to the display or a portion thereof, when the third orientation falls outside the predetermined orientation range. The new orientation of display 102 is, may be for example the display orientation shown in FIG. 3A.

The third measurement can be performed after a predetermined check period from the second measurement. Alternatively, some other period can be used to define a point of time for the new measurement.

In another embodiment the method a timer is used to control the period after which the display is deactivated, so the method may comprise stopping 507 said supplying of power after a default use period. The default use period is typically few seconds after which display 102 is turned off. This embodiment should prevent a discharge of the power source.

In another embodiment the display is being deactivate in response to manual input from the user. In such embodiment the method may comprise stopping 508 said supplying of power due to a command from a user interface of the wrist wearable device. Wrist wearable device 101 comprises buttons 103, 104 one of which could be used for stopping the power supply to display 102. Alternatively, the stopping 508 could be done through a touch panel of wrist wearable device 101.

The method may be implemented so that a user may stop the power supply to display by at least two manners. Then stopping 506 and/or stopping 507 and/or stopping 508 are possible.

FIG. 6 illustrates an example apparatus 601 for controlling power supply to reduce power consumption in a display of a wrist wearable device. The wrist wearable device is, for example, device 101. Apparatus 601 comprises at least one processor 602 and at least one memory 603 including computer program code, wherein the memory and the computer program code are configured to, with the processor, cause apparatus 601 to perform the above described method.

Therefore, apparatus 601 is configured to perform at least the following:
obtaining a first data set 604 from at least one sensor 605 in response to a first measurement, the first data set disclosing a first orientation of the display;
obtaining a second data set 606 from said at least one sensor 605 in response to a second measurement, the second data set disclosing a second orientation of the display after a predetermined check period from the first measurement;
detecting a user need targeted to the display when the first orientation as well as the second orientation substantially correspond to a predetermined orientation of the display; and for the user need,
supplying a portion of power to the display to present a content.

The first data set and the second data set may be composed of signals that are obtained directly from said at least one sensor. Alternatively, the signals are already processed (before apparatus 601 obtains them) and the first data set and the second data set already in a form corresponding to their respective orientations. Generally speaking, the first data set and the second data set comprise measurement results originated from one or more sensors.

In one embodiment said at least one sensor comprises at least one of the following sensors: a gyroscope, a magnetometer, an accelerometer, a light sensor. A person skilled in the art would readily recognize the various ways apparatus 601 can be implemented using one or more above-mentioned sensors, and knowledge common in the art. Furthermore, the sensor may be any sensor from which orientation information may be obtained. The skilled in the art will also understand that other sensors capable of providing orientation related data may be utilized. Sensors may be direct orientation sensors such as a gyroscope and an accelerometer, or indirect sensors, which are sensors normally designed to perform a different function, but from which orientation information may be derived. By way of non-limiting example, orientation may be derived from a camera which identifies objects, uses fiduciaries to determine orientations, and the like.

The apparatus 601 may be a smart watch, device 101, or any type of wrist wearable device, or a component of the wrist wearable device. Therefore, in one embodiment, apparatus 601 is a chip or some other component that can be used in manufacturing the wrist wearable device.

The following three apparatus embodiments concern optional steps of the method which are shown in FIG. 5B.

In one embodiment apparatus 601 performs the steps of
obtaining a new data set from said at least one sensor in response to a new measurement, the new data set disclosing a new orientation of the display after the second measurement; and
disabling the display or portions thereof when the new orientation substantially differs from the predetermined orientation of the display, or otherwise falls outside the orientation range.

In another embodiment apparatus 601 stops the power supply after a predetermined delay.

In another embodiment the apparatus 601 performs: disables the display in response to a command from a user interface of the wrist wearable device.

The predetermined orientation, the predetermined delays and check periods, and the default period to leave the display active may be fixed parameters. Alternatively, a user of the wrist wearable device (such as device 101) can be given the capacity to adjust those parameters. Adjustment may be performed through the user interface of the device, or through a remote device such as a terminal coupled to the device directly or wirelessly. Additional certain example orientations may be set empirically. Thus, in one embodiment the one or more of the above described parameters are adjustable by the user of the wrist wearable device.

In some embodiments apparatus 601 is configured to a set a trigger for detecting an expiry of the predetermined check period or the default use period.

Activation and deactivation of the display may be made by activating and deactivating the display as a whole, or by operating on certain portions of the display, setting operating levels of the display or portions thereof, and the like. Thus, by way of example,

In one embodiment the display is activated by activating or modifying the intensity of a backlight of the display, and deactivated by disabling, or changing the intensity of the backlight.

Where the device comprises a touch panel type display, activating the touch panel is also considered activating the display, and disabling the touch panel is considered a disabling of the display. Clearly, more than one of such action may be taken, and considered an activation or deactivation of the display. Any action to make the display content more clearly available for the user by varying power provided to the display or any portion thereof should be considered as activation. Conversely, any action which lessens the availability of the displayed content by varying power provided to the display or any portions thereof should be considered as deactivation. A touch panel, a backlight, and similar sub-assemblies of the display should be considered portions of the display, even if the specific sub-assembly may be separated from the portion responsible for the presentation of pixels or segments, such as an LCD panel by way of example.

The term processor may relate to a dedicated circuitry acting as a special purpose processor or to a general purpose processor. The processor is commonly operated by software.

Activating or deactivating the display may relate to the whole display, or to portions thereof, such as the display panel, a backlight which may be turned on or off or set to any one of several intensity levels, touch detection, and the like.

The terms ‘first’, ‘second’ and ‘third’ orientations and datasets do not necessitate consecutive measurements of orientations, and any number of intermediate sensing operations, with intermediate corresponding data sets, may be interposed therebetween.

While the present invention has been described in connection with a number of exemplary embodiments, and implementations, the present invention is not so limited, but rather covers various modifications, and equivalent arrangements, which fall within the purview of prospective claims.

We claim:

1. A wrist wearable device comprising:
a processor coupled at least to a display and a sensor;
wherein the processor is configured at least to:
obtain a first dataset from the sensor, the first dataset corresponding to a first instantaneous orientation;
after a predetermined delay, obtain a second dataset corresponding to a second instantaneous orientation; and,
activate the display or a portion thereof, if the first and the second instantaneous orientations fall within an predetermined orientation range.

2. The device as claimed in claim 1, wherein the second dataset is obtained from a different sensor than the sensor from which the first dataset was obtained.

3. The device as claimed in claim 1, wherein the predetermined orientation range is user-adjustable.

4. The device as claimed in claim 3, wherein the predetermined orientation is adjusted by moving the device between a plurality of orientations.

5. The device as claimed in claim 1, wherein the predetermined delay is user-adjustable.

6. The device as claimed in claim 1, wherein the processor is further configured to obtain a third dataset corresponding to a third instantaneous orientation;
and deactivating the display if the third instantaneous orientation is outside a predetermined orientation range;
wherein the third dataset is obtained after a predetermined delay from the activation of the display.

7. The device as claimed in claim 1, wherein the device is configured to deactivate the display after a predetermined delay from the activation of the display.

8. The device as claimed in claim 1, wherein the device is configured to deactivate the display in response to a user input.

9. The device as claimed in claim 1, wherein the display comprises at least one subassembly selected from a backlight, a touch panel, or a combination thereof.

10. The device as claimed in claim 1, wherein the sensor comprises at least one of the following sensors: a gyroscope, a magnetometer, an accelerometer, a light sensor, a camera, and any combination thereof.

11. A method for controlling a wrist wearable device having at least a processor, a display, and a sensor, wherein the sensor and the display are coupled to the processor, the method comprising the steps of:
obtaining a first dataset from the sensor, the first dataset corresponding to a first instantaneous orientation;
after a predetermined delay, obtain a second dataset corresponding to a second instantaneous orientation; and,
activate the display or a portion thereof, if the first and the second instantaneous orientations fall within an predetermined orientation range.

12. The method as claimed in claim 11, wherein the second dataset is obtained from a different sensor than the sensor from which the first dataset was obtained.

13. The method as claimed in claim 12, wherein the predetermined orientation range is user-adjustable.

14. The method as claimed in claim 13, wherein the predetermined orientation range is adjusted by moving the device between a plurality of orientations.

15. The method as claimed in claim 11, wherein the predetermined delay is user-adjustable.

16. The method as claimed in claim 11, further comprising the steps of:
obtaining a third dataset corresponding to a third instantaneous orientation;
and, deactivating the display if the third instantaneous orientation is outside a predetermined orientation range;
wherein the third dataset is obtained after a predetermined delay from the activation of the display.

17. The method as claimed in claim 11, further comprising the step of deactivating the display after a predetermined delay from the activation of the display.

18. The method as claimed in claim 11, further comprising the steps of accepting a manual input from a user, and in response to the manual input, deactivating the display.

19. The method as claimed in claim 11, wherein activating the display comprises at least one of:
displaying content on the display;
changing the intensity of illumination of the display;
activating a touch detection device disposed adjacent to the display or on the display.

20. The method as claimed in claim 11, wherein the wrist wearable device comprises a smart-watch.
